(19) United States
(12) Patent Application Publication
(10) Pub. No.: US 2020/0009734 A1
(43) Pub. Date: Jan. 9, 2020

(54) ROBOT AND OPERATING METHOD THEREOF

(71) Applicant: LG ELECTRONICS INC., Seoul (KR)

(72) Inventor: Jung Sik KIM, Seongnam-si (KR)

(73) Assignee: LG ELECTRONICS INC., Seoul (KR)

(21) Appl. No.: 16/575,223

(22) Filed: Sep. 18, 2019

(30) Foreign Application Priority Data
Jun. 18, 2019 (KR) 10-2019-0072329

(51) Int. Cl. B25J 9/16; B25J 5/00; B25J 19/04; G05B 19/4061; G05D 1/02

(52) U.S. Cl. CPC B25J 9/1666; B25J 5/007; B25J 19/04; G05B 2219/40476; G05B 19/4061; G05D 1/0246; B25J 9/1697

(57) ABSTRACT

A robot disposed in a given space is disclosed. The robot includes a mobile module, a communication unit configured to communicate with a robot control system, at least one sensing unit, an input unit configured to receive a user input or an image signal, a display, and a control module. Upon receiving destination information via the input unit, the control module searches for a movement route based on at least one of image information, spatial map information of the space, or information of a sensed obstacle region. Therefore, artificial intelligence (AI) and 5G communication can be performed by the robot, and user convenience can be improved, resulting in improved movement efficiency of the robot.

### CROSS-REFERENCE TO RELATED APPLICATION

Pursuant to 35 U.S.C. § 119(a), this application claims the benefit of earlier filing date and right of priority to Korean Patent Application No. 10-2019-0072329, filed on Jun. 18, 2019, the contents of which are hereby incorporated by reference herein in its entirety.

### BACKGROUND

### 1. Field of the Invention

The present disclosure relates to a robot and operating method thereof, and more particularly to a robot disposed in a given space so as to avoid collision with an obstacle, and a method for operating the robot.

### 2. Description of Related Art

Robots have been developed for industrial use and have been a part of factory automation. Recently, application fields for robots are rapidly increasing. For example, medical robots, guide robots, and spacecraft robots are being developed. In addition, robots for use in ordinary households are also being developed.

Korean Patent Application Publication No. 20190004959A, entitled “Guidance Robot” (hereinafter referred to as “Related Art 1”), discloses a guidance robot that includes an upper module provided with a processor and a display unit, and a lower module detachably connected to the upper module. The guidance robot also detects a collision based on information sensed by a load sensor.

However, the guidance robot disclosed in Related Art 1 has disadvantages in that the guidance robot cannot detect the approach of an external obstacle and cannot direct a user to a user-desired destination.

Korean Patent Application Publication No. 101480774B, entitled “Apparatus and Method for Recognizing Position of Robot Using the CCTV” (hereinafter referred to as “Related Art 2”), discloses a position recognizing apparatus that uses a closed circuit television (CCTV) camera, such that the position recognizing apparatus monitors movement of a mobile robot to which a marker is attached and controls operation of the mobile robot.

However, the mobile robot disclosed in Related Art 2 is dependent only on image information of the CCTV camera. Therefore, precision and accuracy of detecting the presence or absence of an obstacle become decreased, and there is a limitation in moving the robot and avoiding an obstacle.

### SUMMARY OF THE INVENTION

The present disclosure is directed to providing a method for searching for an optimal route to avoid collision with an obstacle by addressing the shortcomings of an obstacle recognition rate declining in the related art.

The present disclosure is further directed to providing a robot capable of providing a user with various kinds of information, while moving and avoiding collision with an obstacle.

The present disclosure is still further directed to providing a robot capable of avoiding collision with an obstacle, and a robot control system for controlling the robot.

It is to be understood that technical objectives to be achieved by the present disclosure are not limited to the aforementioned technical objectives and other technical objectives which are not mentioned herein will be apparent from the following description to one of ordinary skill in the art to which the present disclosure pertains.

According to an embodiment of the present disclosure, a robot may search for an optimum route using self-acquired information and information received from an external source.

According to one aspect of the present disclosure, when a robot disposed in a given space receives destination information, the robot may search for a movement route based on at least one of image signal information, spatial map information, or information of a sensed obstacle region.

Specifically, a control module may receive, from a robot control system, information of a movable region for the robot from among obstacle regions, and may update the searched movement route based on the received movable region information.

In this case, the movable region information may be determined based on an image photographed by at least one camera installed in an upper part of the space.

Accordingly, the robot may bypass or avoid a congested route using a movement route that is incapable of being self-recognized by the robot.

According to one aspect of the present disclosure, when the robot is spaced apart from a dynamic obstacle by a predetermined distance or less, or collides with the dynamic obstacle, a control module of the robot may perform a specific corresponding motion. Here, the specific corresponding motion may include at least one of a motion for decelerating the robot, a motion for allowing the robot to enter a standby mode, or a motion for allowing the robot to move in response to external manipulation.

In addition, a method for driving a robot control system configured to control a robot disposed in a given space includes receiving information of a movement route and information of at least one obstacle region from the robot, determining a movable region for the robot from among the obstacle regions based on an image photographed by at least one camera installed in an upper part of the space, and transmitting a movement route having the determined movable region to the robot.

### BRIEF DESCRIPTION OF DRAWINGS

The foregoing and other aspects, features, and advantages of the present disclosure, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. The use of the same reference numerals or symbols in different drawings indicates similar or identical items.

The above-mentioned and other aspects, features, and advantages of the present disclosure will become apparent from the detailed description of the following aspects in conjunction with the accompanying drawings, in which:

FIG. 1 and FIG. 2 are views illustrating the external appearance of a robot according to an embodiment of the present disclosure.

FIG. 3 is a block diagram illustrating a robot according to an embodiment of the present disclosure.

FIG. 4 is a conceptual diagram illustrating a method for allowing a robot to effectively establish a movement route according to an embodiment of the present disclosure.

FIG. 5 is a view illustrating a display image of a robot according to an embodiment of the present disclosure.

FIG. 6 is a flowchart illustrating a method for driving a robot control system according to an embodiment of the present disclosure.

FIG. 7 is a conceptual diagram illustrating a robot communication system according to an embodiment of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Reference will now be made in detail to the embodiments of the present disclosure, examples of which are illustrated in the accompanying drawings. Wherever possible, the same reference numbers will be used throughout the drawings to refer to the same or like parts. In the following description, known functions or structures, which may confuse the substance of the present disclosure, are not explained. In the following description of the present disclosure, a detailed description of known functions or configurations incorporated herein will be omitted when it may make the subject matter of the present disclosure rather unclear.

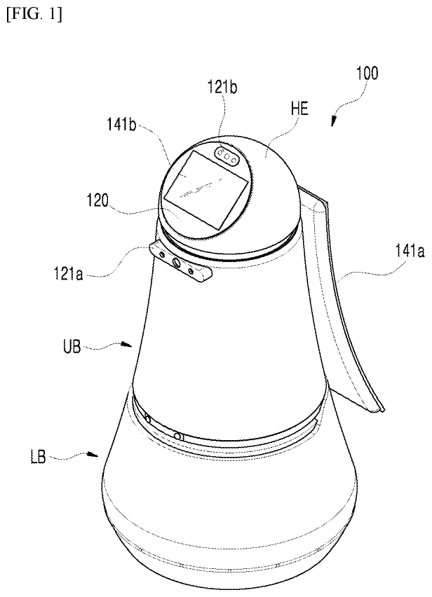

FIG. 1 and FIG. 2 are views illustrating the external appearance of a robot 100 according to an embodiment of the present disclosure.

Referring to FIG. 1 and FIG. 2, the robot 100 may include an upper module UB and a lower module LB. In the robot 100, the upper module UB and the lower module LB may be detachably coupled to each other.

For reference, the robot 100 may be disposed in places such as airports and hospitals to provide a user with various kinds of information, such that the robot 100 may guide or direct the user to a user-desired destination. However, the functions of the robot 100 are not limited to that of information provision and information guidance for users.

In the robot 100, the upper module UB may provide the user with a user interface (UI) that is changeable according to service environments, and may provide the robot 100 with a traveling function for movement.

The upper module UB may include a body unit forming a body, a head unit HE, and a plurality of display units 141a and 141b. The body unit may include a first camera 121a, and the head unit HE may include a second camera 121b. The head unit HE may rotate about the body by a predetermined angle of 180° or higher, so that the display unit 141b can be implemented to face in various directions.

An input unit 120 may include the display unit 141b for receiving a touch input from the user. The display 141b may be implemented as a touchscreen by forming a mutual layer structure together with a touchpad.

The input unit 120 may be oriented to face upward by a predetermined angle in a manner that the user can easily manipulate the input unit 120 while viewing the display unit 141b downward. For example, the input unit 120 may be disposed on a surface formed by cutting a portion of the head unit HE, such that the display unit 141b may be disposed to be inclined.

In other words, a specific structure may be disposed on the input unit 120, or may be painted with specific paints, thereby expressing facial features of a person such as eyes, nose, mouth, and eyebrows on the input unit 120. Therefore, the input unit 120 may be formed to have a shape of a human face, so that emotional sensation can be provided to the user. Moreover, when a robot configured to have the shape of a human face is moving, the movement of the robot may provide the user with the impression that the movement is similar to the movement of a person, so that user reluctance toward the robot can be reduced.

In accordance with another embodiment, one or more images for expressing facial features of a person such as eyes, nose, mouth, and eyebrows may be displayed on the display unit 141b. That is, information not only related to a navigation service, but also various images expressing the shape of a human face may be displayed on the display unit 141b. In addition, an image expressing a predetermined facial expression may be displayed on the display unit 141b at predetermined time intervals or at a specific time.

In FIG. 1, the direction toward which the input unit 120 is oriented will hereinafter be defined as a forward direction, and the opposite direction will hereinafter be defined as a backward direction. Therefore, the robot 100, while moving in a forward direction, can provide various kinds of information to the user following the robot 100 via a large screen of the display unit 141a.

In addition, the head unit HE of the robot 100 may rotate 180° as shown in FIG. 2, such that the head unit HE may be oriented to face in a backward direction. The display unit 141a may provide various kinds of information to the user following the robot 100, and a camera 121c may be included in the display unit 141a, such that the display unit 141a, using the camera 121c, can recognize the user.

Furthermore, an obstacle detection sensor, such as a Light Detection And Ranging (LiDAR) sensor, of the robot 100 may be disposed at a first point 131a in a forward direction, and may be disposed at a second point 131b in a backward direction. Each of the first point 131a and the second point 131b may be provided with a cut surface, such that light emitted from the obstacle detection sensor may move straight in the forward or backward direction. However, the scope of the above-mentioned obstacle detection sensor is not limited thereto and may also be disposed at other positions according to implementation examples.

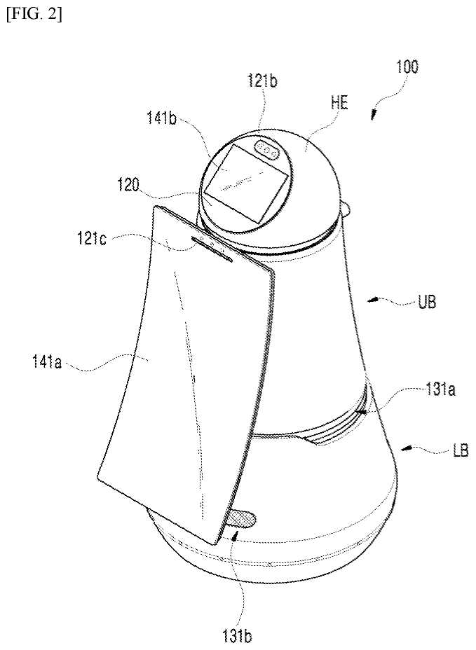

The robot 100 will hereinafter be described with reference to FIG. 3. The robot 100 may include a communication unit 110, an input unit 120, a sensing unit 130, an output unit 140, a storage unit 150, a power supply unit 160, a mobile module 170, and a control module 190. The constituent elements shown in FIG. 3 are not always required to implement the robot 100, such that it should be noted that the robot 100 according to the present disclosure may include fewer or more components than the elements listed above.

Specifically, the communication unit 110 from among the above-mentioned constituent elements may include one or more wired or wireless communication modules which enable the robot 100 to communicate with either a robot control system or a device provided with a communication module. The communication unit 110 comprises at least one of a communicator or consists of at least one of a communicator.

Above all, the communication unit 110 may include a mobile communication module. The mobile communication module may transmit and receive a wireless signal to and from at least one of a base station (B S), an external user equipment (UE), or a robot control system over a mobile communication network that is constructed according to technical standards for mobile communication, communication schemes, such as Global System for Mobile communication (GSM), Code Division Multiple Access (CDMA), Code Division Multiple Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), and 5G communication.

In addition, the communication unit 110 may include a short range communication module. In this case, the short range communication module may be required for short range communication and may perform short range communication using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, or Wireless Universal Serial Bus (Wireless USB).

The input unit 120 may include a camera 121 or an image input unit for receiving image signals, a microphone 123 or an audio input unit for receiving audio signals, and a user input unit such as a touch-type key and a push-type mechanical key for receiving information from the user. The camera 121 may also be implemented as a plurality of cameras as necessary. The input unit comprises at least one of a inputter or consists of at least one of a inputter. The inputter may be configured to input data and signal.

The sensing unit 130 may include one or more sensors for sensing at least one of internal information for the robot 100, peripheral environmental information for the robot 100, and user information. For example, the sensing unit 130 may include at least one of an obstacle detection sensor 131 such as a proximity sensor and a Light Detection And Ranging (LiDAR) sensor, a weight detection sensor, an illumination sensor, a touch sensor, an acceleration sensor, a magnetic sensor, a gravity sensor (G-sensor), a gyroscope sensor, a motion sensor, an RGB sensor, an infrared (IR) sensor, a fingerprint recognition sensor, an ultrasonic sensor, an optical sensor (for example, see the camera 121), a microphone (for example, see 123), a battery gauge, an environmental sensor such as a barometer, a hygrometer, a thermometer, a radioactivity detection sensor, a heat detection sensor, and a gas detection sensor, or a chemical sensor such as an electronic nose, a healthcare sensor, and a biometric sensor. On the other hand, the robot 100 disclosed in the present disclosure may combine various kinds of information sensed by at least two of the above-mentioned sensors and may use the combined information. The sensing unit 130 comprises at least one of a sensor.

The output unit 140 may generate output signals related to visual, auditory, or tactile sensation. The output unit 140 may include at least one of a display unit 141 (where, although plural display units can also be used as necessary, a representative example of the display unit disclosed in the present disclosure is denoted by the display unit 141a of FIG. 1 for convenience of description), one or more light emitting devices, a sound output unit, or a haptic module. The display unit may construct a mutual layer structure along with a touch sensor or may be formed integrally with the touch sensor, such that the display unit can be implemented as a touchscreen. The touchscreen may serve as a user input unit that provides an input interface to be used between the robot 100 and the user, and at the same time, may provide an output interface to be used between the robot 100 and the user.

The storage unit 150 may store data needed to support various functions of the robot 100. The storage unit 150 may store a plurality of application programs (or applications) to be driven by the robot 100, data needed to operate the robot 100, and commands for the robot 100. At least some of the application programs may be downloaded from an external server via wireless communication. In addition, the storage 150 may store user information for performing an interaction with the robot 100. The user information may be used to identify the recognized user.

Under control of the control module 190, the power supply unit 160 receives power externally or internally and may supply power to constituent elements of the robot 100. The power supply unit 160 may include a battery which may be implemented as an embedded battery or a replaceable battery. The battery may be charged using a wired or wireless charging method. Here, the wireless charging method may include a magnetic induction method or a magnetic resonance method.

The mobile module 170 may be a module for moving the robot 100 to a predetermined destination under the control of the control module 190 and may include one or more wheels. The mobile module 170 comprises at least one of a wheel driver or consists of at least one of a wheel driver. The wheel driver may be configured to move the robot 100 to a predetermined destination under the control of the control module 190.

The control module 190 may move the robot 100 from one place to another place. When the control module receives destination information via the input unit 120, the control module 190 may move the robot 100 to the destination. In this case, the destination information may be received via, for example, a touch input, a voice input action, and a button input available in the input unit 120 shown in FIG. 1.

The control module 190 may store spatial map information corresponding to a given space in the storage unit 150. According to implementation examples, the spatial map information may also be received from an external robot control system as necessary. The control module 190 comprises at least one of a controller or consists of at least one of a controller.

The control module 190 may search for a movement route to a destination based on information from a photograph taken by the camera 121, spatial map information, and obstacle region information sensed by the sensing unit 130. The control module 190 may display the searched movement route on the display unit 141.

In addition, the control module 190 may request information about a movable region for the robot 100 from among a plurality of obstacle regions from the robot control system. The robot control system may search for a movable space for the robot 100 in a peripheral region of obstacles by receiving images photographed by cameras located in the upper part of the space, and may transmit the searched movable space information to the robot 100.

According to another embodiment, the control module 190 may photograph external obstacles using one or more cameras, and may determine the presence or absence of the movable region by referring to shape and characteristic information of the obstacles. For example, the control module 190 may estimate the size of a corresponding obstacle and a space occupied by the corresponding obstacle by referring to size, material, and shape information of the obstacles, and may detect the movable region for the robot 100 in the peripheral regions of the obstacles.

The control module 190 may display image signal information received on the movement route on the display unit 141. In other words, an image viewed by the robot 100 through the camera may be displayed on the display unit 141. Accordingly, the user following the robot 100 can view the image displayed on the display unit 141.

In addition, when at least one camera installed to photograph a target space from a top-view standpoint photographs the robot 100 disposed on the movement route and a contiguous region, the control module 190 may receive the photographed image via the communication unit 110 and display the image on the display unit 141. In this case, information about a present movement place of the user may be displayed on the display unit 141, such that user convenience can be improved.

The control module 190 may virtually divide the entire region of the display unit 141 into a plurality of divided regions, and may display an image on the plurality of divided regions. Specifically, the control module 190 may control the display unit 141, so that an image indicating a movement route for the robot 100 on the spatial map is displayed in a first divided region of the display unit 141, image signal information received via the input unit 120 on the movement route is displayed in a second divided region of the display unit 141, and a top-view image taken by the camera installed to photograph the robot 100 disposed on the movement route and the contiguous region is displayed in a third divided region of the display unit 141.

In addition, the control module 190 may recognize a static obstacle and a dynamic obstacle. Specifically, when the dynamic obstacle moving in the same direction as the robot 100 is recognized, the control module 190 may control the mobile module 170 in a manner that the robot 100 can move in response to a movement speed of the recognized dynamic obstacle.

In addition, when a specific emergency situation such as a collision occurs, the control module 190 may perform a specific motion corresponding to the emergency situation. The specific motion may be a passive motion and may include various motions, for example, a motion for decelerating the robot 100, a motion for allowing the robot 100 to enter a standby mode, and a motion for pending movement for the robot 100 and then moving the robot 100 according to an external manipulation. However, the embodiment is not limited thereto.

On the other hand, the method for driving the robot 100 according to an embodiment of the present disclosure may search for a movement route based on at least one of input image signal information, spatial map information, or the sensed obstacle region information when destination information is inputted into the robot 100. Thereafter, the robot 100 may receive information about a movable region from among the obstacle regions from the robot control system. Thus, the robot 100 may update the movement route based on the received movable region information.

In this case, the robot 100 may perform various operations to avoid collision with the obstacles. Specifically, when the robot 100 recognizes the dynamic obstacle that moves in the same direction as the robot 100, the robot 100 may move in response to a movement speed of the recognized dynamic obstacle, and may perform the above-mentioned passive motion. Although the dynamic obstacle that moves in the same direction as the robot 100 may be a dynamic obstacle located closest to the robot 100, the scope of the present disclosure is not limited thereto.

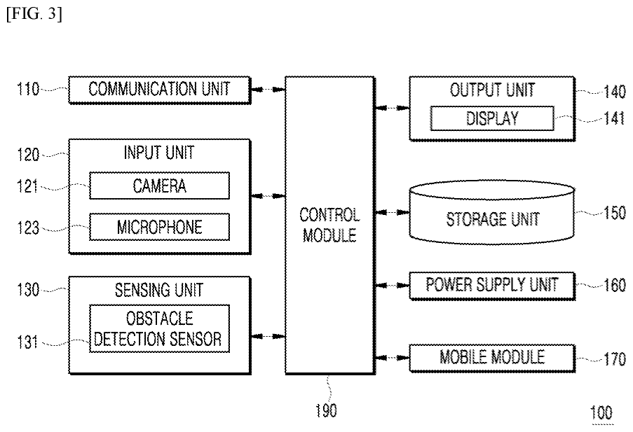

FIG. 4 is a conceptual diagram illustrating a method for driving a robot 100a configured to effectively improve a movement route according to an embodiment of the present disclosure.

Referring to FIG. 4, one or more cameras 221a-221d may be installed in an upper part of a given space. The cameras 221a-221d may photograph the space from a top-view standpoint and may be implemented to perform a three-dimensional (3D) reconstruction function.

The robot 100a may store spatial map information corresponding to the space in a storage unit 150.

The robot 100a may initially move from a departure point SP to a destination point EP. The robot 100a includes an obstacle detection sensor 131 and recognizes light reflected from an obstacle, so that the robot 100a can recognize the distance to the obstacle. If the robot 100a uses information from photographs taken by built-in cameras embedded therein and other information sensed by the obstacle detection sensor 131 at the departure point SP, the robot 100a may search for only a first route Pa1 or a second route Pa2.

This is because the obstacle detection sensor 131 cannot search for a movable region 20 located around the obstacle at the departure point SP. The obstacle detection sensor 131 may create a grid map and may display a plurality of obstacles sensed by the obstacle detection sensor 131 on the grid map in all directions based on the position of the robot 100a. The obstacle detection sensor 131 may measure the distance to each obstacle, such that the obstacle detection sensor 131 may display several obstacles located in the vicinity of the robot 100a on the grid map.

In this case, the robot 100a may provide a robot control system with information about the movement route. The robot control system may collect, from the cameras 221a-221d, information about the movable region 20 for the robot 100 from among the obstacle regions, such that the robot control system may update the movement route based on the collected information, and may provide the robot 100 with information about the updated movement route.

Thus, the robot 100a may move to the destination EP after passing through the movable region 20 from among the obstacle regions. Therefore, the distance of the movement route and a time needed for the movement route can be reduced, such that movement efficiency of the robot 100a and user convenience can be improved.

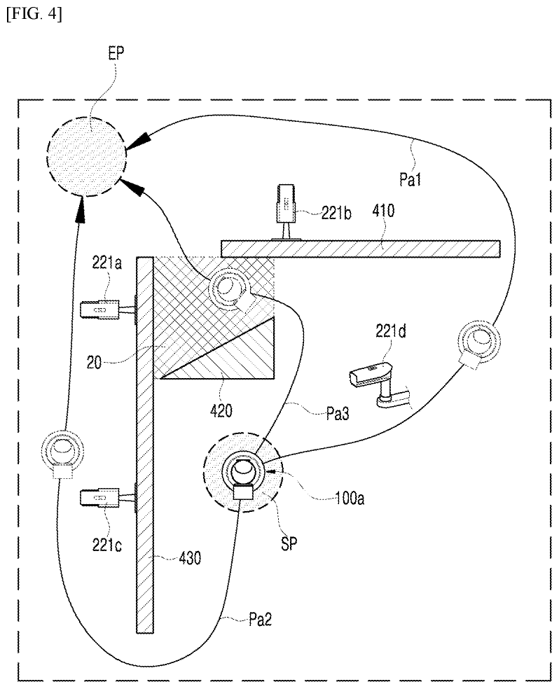

FIG. 5 is a view illustrating a display image provided by a robot 100 according to an embodiment of the present disclosure.

Referring to FIG. 5, the robot 100 may display a screen image in an upper region of a display unit 141, such that the screen image may display a movement route on a spatial map. For example, the screen image may display a movement route to a currency exchange office, and may display estimated distance and time information needed to reach the currency exchange office.

In addition, the robot 100 may display images photographed by cameras located in an upper part of a space on a divided region 530. Here, the photographed images may be displayed as such that the robot 100 is facing a forward direction.

Furthermore, the robot 100 may display images photographed by the cameras installed in the upper part of the space on another divided region 520. The images may be received from a robot control system. Accordingly, various kinds of information can be provided to a user, resulting in improved user convenience.

In this case, the robot 100 may receive information about a possibility of collision with an obstacle from the robot control system. Here, the robot 100 may have difficulty in recognizing whether the possibility of collision is high or low by using autonomous sensing or a photographing action. If the robot 100 receives the above-mentioned information, information about a current state in which the robot 100 is moving can be audibly outputted via an output unit 140. The robot 100 may also wait to move in the space.

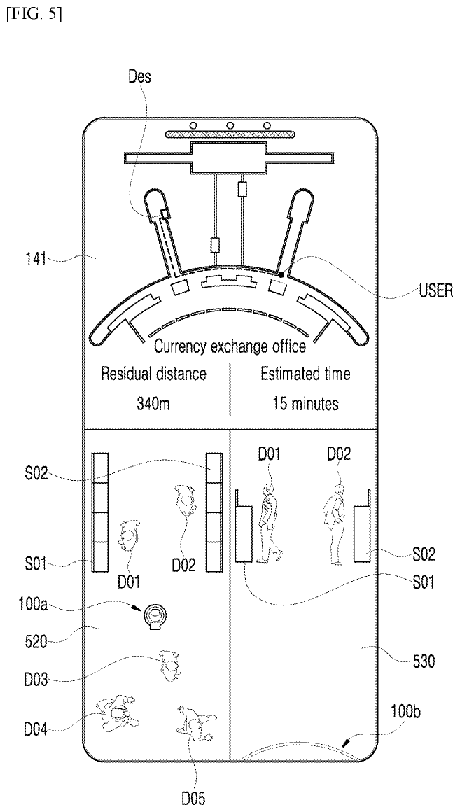

FIG. 6 is a flowchart illustrating a method for driving a robot control system according to an embodiment of the present disclosure.

Referring to FIG. 6, the robot control system may receive destination information and information about a sensed obstacle region from a robot 100 (S610).

Thereafter, the robot control system may create (S620) or update a movement route based on destination information for the robot 100, information about the obstacle regions, information about a movable region from among the obstacle regions, and spatial map information.

Finally, the robot control system may control the robot 100 to move based on the movement route (S630).

In this case, when the robot 100 moving along the movement route and the contiguous region of the robot 100 are photographed by at least one camera installed at the upper part of the space, the robot control system may transmit the photographed image to the robot 100.

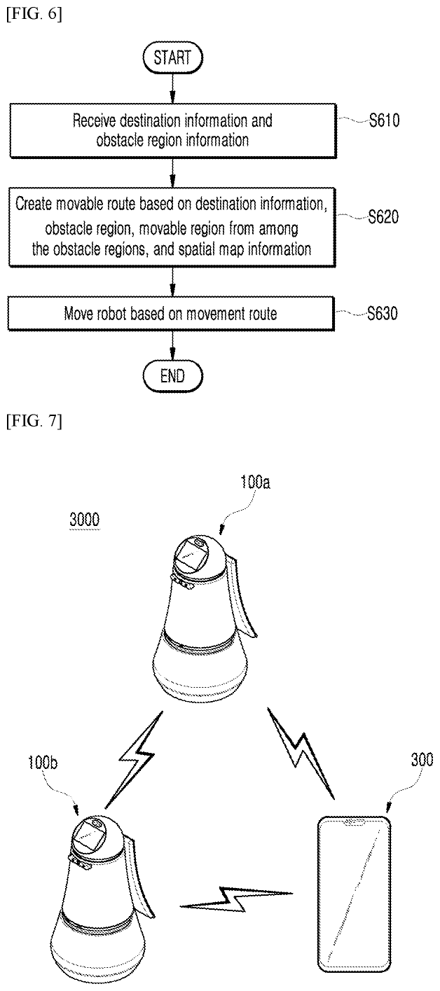

FIG. 7 is a conceptual diagram illustrating a robot communication system 3000 according to an embodiment of the present disclosure.

Referring to FIG. 7, the robot communication system 3000 may include a first robot 100a, a second robot 100b, and a mobile terminal 300. In this case, the mobile terminal 300 may be replaced with, for example, a vehicle, a device, or an IoT device, as necessary. Each mobile terminal 300 and each of the robots 100a and 100b may include the above-mentioned 5G communication module.

In this case, the first robot 100a may transmit data at a transfer rate of 100 Mbps to 20 Gbps, such that high-capacity moving images can be transferred to the second robot 100b and the mobile terminal 300.

The first robot 100a provided with a 5G communication module may provide the second robot 100b with spatial map information that is based on at least one of autonomously photographed image information, spatial map information, obstacle region information, or movable region information. In addition, the second robot 100b provided with such a 5G communication module may transmit spatial map information to the first robot 100a.

Accordingly, each of the robots 100a and 100b can accurately recognize a space based on information received from the counterpart robot, and can quickly search for an obstacle avoidance route.

In addition, spatial map information received from the counterpart robot, information about a photographed image obtained while in motion, and information about an image photographed from an upper part of a space may be displayed on a display unit of each robot 100a or 100b.

Furthermore, each robot 100a or 100b having the 5G communication module may support a variety of M2M (Machine to Machine) communication, such as Internet of Things (IoT), Internet of Everything (IoE), and Internet of Small Things (IoST). The robots 100a and 100b may support, for example, M2M (Machine to Machine) communication, Vehicle to Everything (V2X) communication), and D2D (Device to Device) communication. Therefore, the robots 100a and 100b may share various kinds of information capable of being acquired from the space with various devices.

The above-mentioned present disclosure may be implemented as a computer-readable code in a recording medium in which a program is written. The computer-readable medium may include all kinds of recording devices in which computer-readable data is stored. Examples of the computer-readable medium may include a Hard Disk Drive (HDD), a Solid State Drive (SSD), a Silicon Disk Drive (SDD), a Read Only Memory (ROM), a Read Access Memory (RAM), a compact disc read only memory (CD-ROM), a magnetic tape, a floppy disk, and an optical data storage device. In addition, the above-mentioned computer may also include a control module 190 of a robot 100.

As is apparent from the above description, the above-mentioned embodiments of the present disclosure may acquire the following effects.

First, the embodiments of the present disclosure may search for a route that has not been recognized by a robot, such that movement efficiency of the robot can be improved, resulting in improved user convenience.

Second, the embodiments of the present disclosure may provide a robot that is capable of avoiding or bypassing an obstacle, such that the efficiency of a time duration needed to search for the route can be improved, resulting in improved user convenience.

In the foregoing, while specific embodiments of the present disclosure have been described for illustrative purposes, the scope of the present disclosure is not limited thereto, and it will be understood by those skilled in the art that various changes and modifications can be made to other specific embodiments without departing from the scope of the present disclosure. Accordingly, the scope of the present disclosure is limited by the disclosed embodiments, but should be determined by the technical idea set forth in the claims. Although the present disclosure has been described with reference to the embodiments, various changes or modifications can be made by those skilled in the art. Accordingly, it is to be understood that such changes and modifications are within the scope of the invention. Such modifications should not be individually understood from the technical prospect of the present disclosure.

What is claimed is:

1. A robot disposed in a given space, comprising:
a wheel driver;
a communicator configured to communicate with a robot control system;
an inputter configured to receive a user input or an image signal;
a display; and
a controller configured to, upon receiving destination information via the inputter, search for a movement route based on at least one of image information, spatial map information of the space, or information of a sensed obstacle region,
wherein, upon receiving information of a movable region of the robot from the robot control system, the controller updates the movement route based on the received movable region information.

2. The robot according to claim 1, wherein the movable region information is determined based on an image photographed by at least one camera installed in an upper part of the space.

3. The robot according to claim 1, wherein:
the inputter includes at least one camera; and
the controller displays image information photographed by the camera on the movement route on the display.

4. The robot according to claim 1, wherein the display receives an image acquired when the robot and a contiguous region of the robot are photographed via the communicator, and displays the received image on the display.

5. The robot according to claim 1, wherein the display is virtually divided into a plurality of regions,
wherein the plurality of regions includes a first region for displaying an image indicating the movement route of the robot, a second region for displaying an image received via the inputter, and a third region for displaying an image that is acquired when the robot and a contiguous region of the robot are photographed and is then received via the communicator.

6. The robot according to claim 1, wherein:
when a dynamic obstacle moving in the same direction as the robot is recognized, the controller controls the wheel driver to move in response to a movement speed of the recognized dynamic obstacle.

7. The robot according to claim 6, wherein:
when the robot is spaced apart from the dynamic obstacle by a predetermined distance or less, or collides with the dynamic obstacle, the controller controls the wheel driver to perform a specific corresponding motion.

8. The robot according to claim 7, wherein the specific corresponding motion includes at least one of a motion for decelerating the robot, a motion for allowing the robot to enter a standby mode, or a motion for allowing the robot to move in response to external manipulation.

9. A method for driving a robot disposed in a given space, the method comprising:
upon receiving destination information, searching for a movement route based on at least one of image information, spatial map information, or obstacle region information;
receiving information of a movable region of the robot from among the obstacle regions from a robot control system; and
updating the movement route based on the received movable region information.

10. The method according to claim 9, wherein the movable region information is determined based on an image photographed by at least one camera installed in an upper part of the space.

11. The method according to claim 9, further comprising:
when a dynamic obstacle moving in the same direction as the robot is recognized, moving the robot in response to a movement speed of the recognized dynamic obstacle.

12. The method according to claim 11, wherein:
when the robot is spaced apart from the dynamic obstacle by a predetermined distance or less, or collides with the dynamic obstacle, performing a specific corresponding motion.

13. The method according to claim 12, wherein the specific corresponding motion includes at least one of a motion for decelerating the robot, a motion for allowing the robot to enter a standby mode, or a motion for allowing the robot to move in response to external manipulation.

14. A method for driving a robot control system configured to control a robot disposed in a given space, the method comprising:
receiving information of a movement route and information of an obstacle region from the robot;
determining a movable region of the robot from among the obstacle regions based on images photographed by at least one camera installed in an upper part of the space; and
transmitting a movement route having the determined movable region to the robot.

15. The method according to claim 14, further comprising:
when the robot moving along the movement route and a contiguous region of the robot are photographed by at least one camera installed in the upper part of the space, transmitting the photographed image to the robot.
